(19) United States
(12) Patent Application Publication
(10) Pub. No.: US 2024/0329221 A1
(43) Pub. Date: Oct. 3, 2024

(54) OPTIMIZED MONOSTATIC LiDAR

(71) Applicant: 3D at Depth, Inc., Longmont, CO (US)

(72) Inventor: Carl W. Embry, Boulder, CO (US)

(73) Assignee: 3D at Depth, Inc., Longmont, CO (US)

(21) Appl. No.: 18/618,818

(22) Filed: Mar. 27, 2024

Related U.S. Application Data
(60) Provisional application No. 63/492,307, filed on Mar. 27, 2023.

(51) Int. Cl. G01S 7/499; G02B 27/28

(52) U.S. Cl. CPC G01S 7/499; G02B 27/283; G02B 27/286

(57) ABSTRACT

Described herein are methods and systems for remote, contactless, laser sensing through a LiDAR system having an improved monostatic optical configuration. The LiDAR system includes a beam splitter that co-aligns the transmit and receive beams with reduced loss to either the transmit or receive beam when compared to traditional methods. The polarizing beam splitter can include a beam splitting surface having a first zone that is polarization selective and a second zone that is not polarization selective. The light source of the LiDAR system is aligned to pass light having a first selected linear polarization to a scene via the first zone. Light received at the LiDAR system as a return signal is passed to a detector by both the first and second zones of the beam splitter. This can significantly reduce receive signal loss if the receiver aperture size is not large compared to the transmit aperture.

### CROSS-REFERENCE TO RELATED APPLICATIONS

This application claims the benefit of U.S. Provisional Patent Application Ser. No. 63/492,307, filed Mar. 27, 2023, the entire disclosure of which is hereby incorporated herein by reference.

### FIELD

The present disclosure is directed to methods and systems for remote, contactless, laser sensing.

### BACKGROUND

Light detection and ranging (LiDAR) systems typically have one of two different architectures for the viewing optics, bistatic or monostatic. Bistatic systems typically have two separate viewing ports or windows, one for the transmitter and one for the receiver. A distinct advantage of this architecture is any back reflection from the transmitted laser does not reflect back to the receiver. Strong back reflections from the transmitter can cause a large return (often called the “big bang”) on the receiver that can temporarily oversaturate the receiver and blind it to any near-field returns. The transmit window is usually small as the laser beam is normally small in diameter, and the receiver window is normally large to enable a larger receive aperture to collect more of the return signal photons.

Bistatic systems have two distinct disadvantages. As the bistatic arrangement has different windows for the transmitter and receiver, there is a blind spot where the Field of View (FoV) of both do not overlap. This blind spot is typically in the near field, so if the bistatic system is, for instance, aircraft mounted for looking at the ground this blind spot is not detrimental to the purpose of the sensor. However, if one desires both closeup and distant detection with the LiDAR then the blind spot in bistatic systems becomes problematic.

A second disadvantage of bistatic systems is scanning. A scanner would be required to scan both the transmit and receiver aperture. This can drastically increase the size of the scanner aperture, thus significantly increasing the size, weight, and power of the entire system. Another option is to scan the transmitter and receiver with separate scanning systems, however this then requires two scanner assemblies that must remain synchronized and aligned throughout operation. This again adds complexity and expense, especially in harsh environments.

The second type of LiDAR architecture, as mentioned, is monostatic. As the name implies, a monostatic system has a single aperture, port or window. The transit and receive optical paths must therefore be integrated or combined prior to the window. The primary advantage of the monostatic system is it allows for simultaneous scanning of the transmitter and receiver through the same scanning system. This eliminates the need for two scanners or one single larger scanner. The second advantage is, since the transmitter and receiver are co-aligned, there is no near-field blind spot. A monostatic system can therefore receive valid returns from a few millimeters distance to hundreds of meters distance or greater.

A disadvantage of the monostatic LiDAR is the loss of signal return through the co-alignment process. There are three primary co-alignment methods. First is a mirror with an aperture (hole) in the middle. For instance, a mirror mounted at a 45 degree angle with a hole through the middle. The laser transmits through the hole to the target. Scattered light is received by the mirror and directed towards a receiver path. Any light coming directly back through the hole is lost to the receiver. This is not a significant issue if the receive aperture is very large compared to the transmit aperture (hole). However, significant receive signal can be lost if the receiver aperture size is not large compared to the transmit aperture, as occurs with smaller, compact, lower cost LiDARs.

Another method is to have a small obscuration or secondary mirror in front of the primary mirror. The secondary mirror is usually at a 45 deg angle so it reflects a laser from the side directly in-line with the receive Field of View. But again, any return light hitting this mirror is lost to the receiver. This is not a significant issue if the receive aperture is very large compared to the transmit aperture (secondary mirror). However, significant receive signal can be lost if the receiver aperture size is not large compared to the transmit aperture, as occurs with smaller, compact, lower cost LiDARs.

A third method is to use a beam splitter (for instance a 50/50 beam splitter) where 50% of the transmit light is lost upon transmission and 50% is lost upon return. This is a highly inefficient approach.

Another method is to use a polarizing beam splitter. The outgoing laser light is normally polarized so high transmission through the beam splitter is possible. The orthogonal polarized light is reflected efficiently in a perpendicular path. However, any other polarization of light is not efficiently reflected into the receiver path.

Accordingly, it would be desirable to provide systems and methods that allowed for the non-contact, remote, LiDAR measurement of a scanned monostatic systems in which return signal loss was reduced.

### SUMMARY

The present disclosure provides monostatic LiDAR systems and methods in which return signal loss is minimized. In accordance with embodiments of the present disclosure, a monostatic LiDAR system is provided that includes a beam splitter with a beam splitting surface having first and second zones. The first zone can be provided as an area or aperture within a larger area made up of the second zone. The first zone acts selectively with respect to incident light. The second zone does not feature the selectivity of the first zone. According to at least some embodiments of the present disclosure, the first zone is configured as a zone that selectively transmits light having a first characteristic, while the second zone is configured as a zone that reflects light, including light having the first characteristic. In accordance with other embodiments of the present disclosure, the first zone is configured as a zone that selectively reflects light having a first characteristic, while the second zone is configured as a zone that transmits light, including light having the first characteristic. Light from the light source is passed through or directed by the beam splitter to a scanner, which directs the beam within the field of view of the LiDAR system. Light reflected from within the field of view is collected by the scanner as a return signal. At least some of the light within the return signal is then reflected or transmitted by the beam splitter, and received at a detector.

In accordance with at least some embodiments of the present disclosure, the light source is configured to output light of a first linear polarization that is directed to the first zone of the beam splitter. The first zone of the beam splitter is configured to transmit light of the first linear polarization and to reflect light of other polarizations. The second zone of the beam splitter can be configured to reflect light of any polarization. Accordingly, except for light of the first linear polarization that is incident on the first zone, all of the light in a return signal collected by the scanner can be reflected to the detector.

In accordance with other embodiments of the present disclosure, the light source is configured to output light of a first linear polarization that is directed to the first zone of the beam splitter. The first zone of the beam splitter is configured to reflect light of the first linear polarization and to transmit light of other polarizations. The second zone of the beam splitter can be configured to transmit light of any polarization that is returned to the scanner. Accordingly, except for light of the first linear polarization that is incident on the first zone, all of the light in the return signal collected by the scanner can be passed to the detector.

In accordance with at least some embodiments of the present disclosure, the beam splitter can be configured as a polarizing beam splitter. In accordance with further embodiments of the present disclosure, the transmission area includes a switchable media that can be selectively configured to transmit light from the light source or reflect light received as part of a return signal.

Methods in accordance with embodiments of the present disclosure include providing a LiDAR system with a beam splitter having first and second zones. The first zone is configured to act differently with respect to light of different polarizations. The second zone is configured to have the same effect on light of any polarization. The first zone can be provided as a transmission area while the second zone can be provided as a reflecting surface. Alternatively, the first zone can be provided as a polarization selective reflective surface while the second zone can be provided as a polarization agnostic transmitter. In accordance with embodiments of the present disclosure, the first zone is surrounded by the second zone. A light source is configured to transmit a beam of light having a first selected polarization to the first zone of the beam splitter. A receiver is disposed to receive a return signal from the environment surrounding the LiDAR system that is passed to it by the scanner and by the second zone of the beam splitter.

In accordance with at least some embodiments of the present disclosure, the method includes providing a polarizing beam splitter that transmits light having a first polarization (e.g. a P-polarization) and that reflects light having a second polarization (e.g. a S-polarization) that is orthogonal the first polarization, as the beam splitter. The first zone can then correspond to an area or aperture within the second zone that is not provided with a reflective or mirrored surface. The light source is then configured to provide light having the first polarization (e.g. a P polarization). Such a configuration can increase the efficiency of the LiDAR system by configuring the first zone, in this case an area that transmits light received from the light source, such that light within a return signal having a polarization other than the first polarization is reflected toward the detector by the first zone, in addition to the light of any polarization that is reflected toward the detector by the mirrored surface of the second zone.

In accordance with other embodiments of the present disclosure, the method includes providing a polarizing beam splitter that reflects light having a first polarization (e.g. a S-polarization) and that transmits light having a second polarization (e.g. a P-polarization) that is orthogonal the first polarization, as the beam splitter. The light source is then configured to provide light having the first polarization (e.g. a S polarization). Such a configuration can increase the efficiency of the LiDAR system by configuring the first zone, in this case an area that reflects light received from the light source, such that a portion of a return signal incident on the first zone and having a second linear polarization (or any polarization other than the first linear polarization) is passed to the receiver, in addition to a portion of the return signal incident on the second zone and having any polarization.

Additional features and advantages of embodiments of the present disclosure will become more readily apparent from the following description, particularly when taken together with the accompanying drawings.

### BRIEF DESCRIPTION OF THE DRAWINGS

FIG. 1 depicts a prior art monostatic LiDAR system using a mirror with a central aperture;

FIG. 2 depicts a prior art monostatic LiDAR system using a polarizing beam splitter;

FIG. 3 depicts a monostatic LiDAR system in accordance with embodiments of the present disclosure;

FIGS. 4A-4C depict aspects of a polarizing beam splitter in accordance with embodiments of the present disclosure;

FIG. 5 depicts a monostatic LiDAR system in accordance with other embodiments of the present disclosure;

FIG. 6 depicts a monostatic LiDAR system in accordance with other embodiments of the present disclosure;

FIG. 7 depicts a monostatic LiDAR system in accordance with other embodiments of the present disclosure;

FIGS. 8A-8C depict aspects of a polarizing beam splitter in accordance with other embodiments of the present disclosure; and

FIG. 9 is a flowchart depicting aspects of a method in accordance with embodiments of the present disclosure.

### DETAILED DESCRIPTION

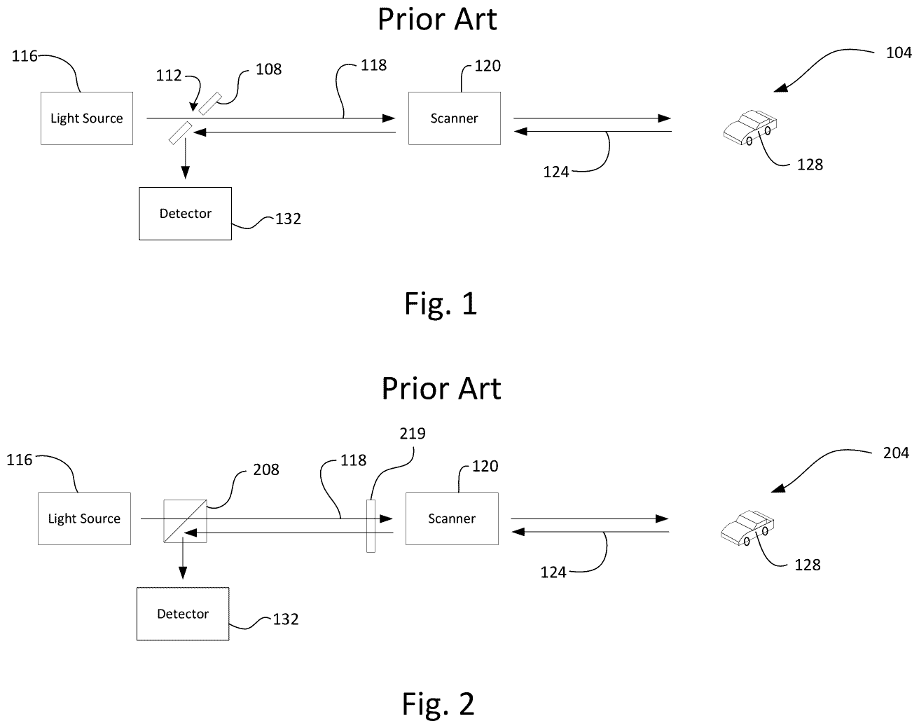

FIG. 1 depicts an example of a prior art monostatic LiDAR system 104 using a mirror 108 with a central aperture 112 formed therein. A light source 116, such as a laser, is positioned to transmit a beam 118 through the central aperture 112 to a scene within a field of view defined by a system scanner 120. A return signal 124, in the form of light reflected from an object 128 within the scene encompassed by the field of view of the LiDAR system 104 and collected by the system scanner 120 is passed to the mirror 108. Portions of the return signal 124 incident on the mirror 108, outside of the central aperture 112 area, are directed to a receiver 132 in the form of a detector or detector array. Portions of the return signal 124 incident on the central aperture 112 formed within the mirror 108 are not directed to the receiver or detector 132, and thus that portion of the return signal 124 is lost.

FIG. 2 depicts an example of a prior art monostatic LiDAR system 204 using a polarizing beam splitter 208 configured to transmit light of a first linear polarization (e.g. a P-polarization) and to reflect light of a second linear polarization (e.g. a S-polarization). In this example configuration, the light source 116 is positioned to transmit a beam 118 having the first selected linear polarization (e.g. a P-polarization) through the polarizing beam splitter 208. The light of the first selected linear polarization is then circularly polarized by a quarter wave plate 219, and is directed to a scene within the field of view by a system scanner 120. A return signal 124 reflected by an object 128 and collected by the system scanner 120 is then passed through the quarter wave plate 219 and to the polarizing beam splitter 208, which reflects light of the second linear polarization toward a detector 132. In a typical operating scenario, the return signal contains light having a mixture of polarizations of light, therefore only a portion of the return signal is passed to the detector 132.

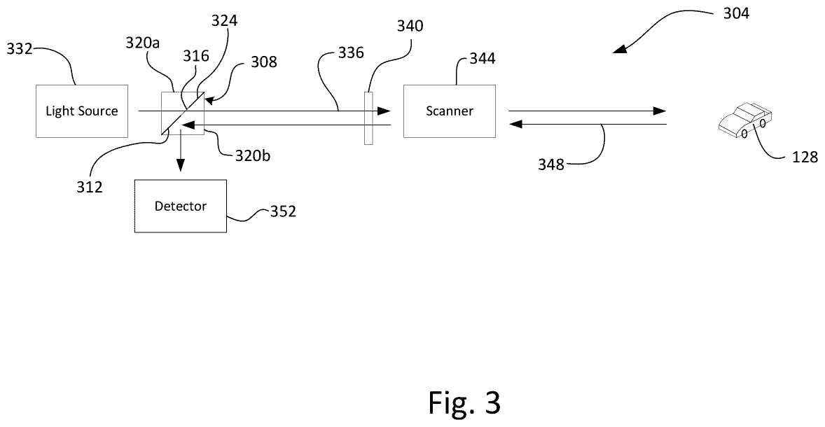

With reference now to FIG. 3, a LiDAR system 304 in accordance with embodiments of the present disclosure is depicted. In this example, the LiDAR system 304 features a beam splitter 308. Similar to certain conventional LiDAR system configurations, the beam splitter 308 in such embodiments is a polarizing beam splitter that is configured to transmit light of a first linear polarization (e.g. a P-polarization) and to reflect light of a second linear polarization (e.g. a S-polarization). A reflective beam splitting surface 324 of the beam splitter 308 is disposed at a non-zero angle to light output from the LiDAR system 304 light source 332. In addition, in accordance with embodiments of the present disclosure, the beam splitting surface 324 includes a first zone 316 that is surrounded by a second zone 312. In this example, the second zone 312 is configured as or is covered by a reflective surface that extends across all but a transmission area or portion 318 corresponding to the first zone 316 of the beam splitting surface 324.

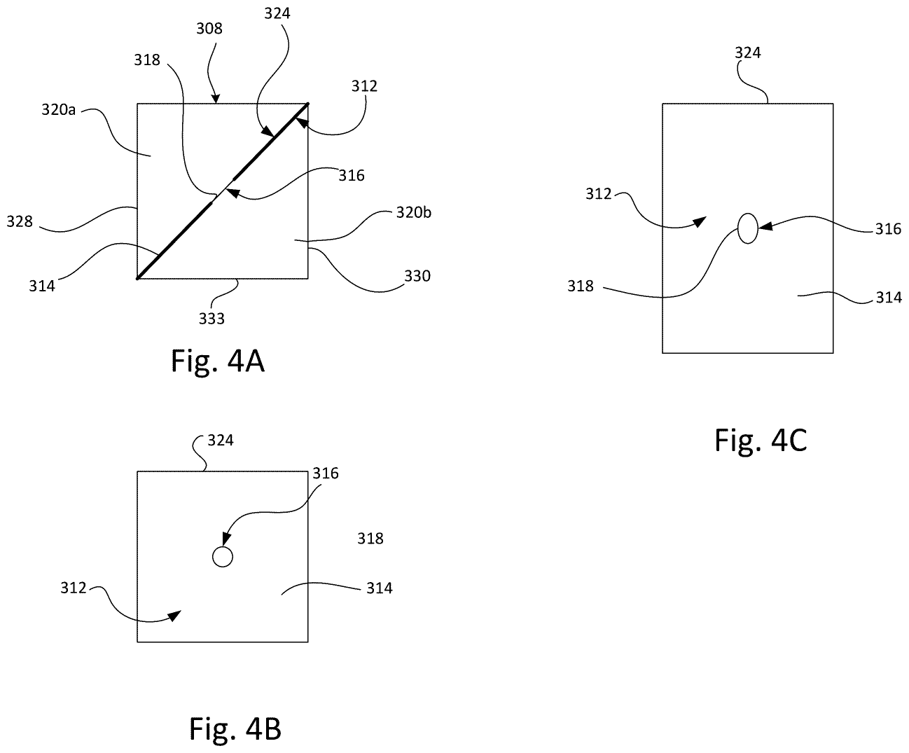

More particularly, and with reference now also to FIG. 4A, which presents a side view in elevation of the beam splitter 308, FIG. 4B, which presents a front view in elevation of the beam splitter 308, and FIG. 4C, which presents a view of beam splitting surface 324 along a line that is perpendicular to that surface, the beam splitter 308 can be formed from two triangular sections 320a and 320b that are joined to form a cube. A mirrored reflecting surface 314 forms the second zone 312 and is disposed along the beam splitting surface 324 formed at the interface between the two triangular sections or prisms 320a and 320b. For example, the mirrored reflecting surface 314 of the second zone 312 can be provided as a reflective coating on the beam splitting surface 324 of the first triangular section 320a. The mirrored reflecting surface 314 can be formed from a reflective coating that reflects light of any polarization. The reflective coating 314 can include a metallic, dielectric, or a combination of metallic or dielectric materials. The transmission area 318 that forms the first zone 316 can be formed as an area in which the mirrored reflecting surface 314 of the second zone 312 is absent. In accordance with embodiments of the present disclosure, the transmission area 318 of the first zone 316 can be formed in a central portion of the area of the beam splitting surface 324 that otherwise forms or supports the reflecting surface 314 of the second zone 312. Moreover, when considered along a line that is orthogonal to the beam splitting surface 324, the first zone 316 can be elliptical in form. As can be appreciated by one of skill in the art after consideration of the present disclosure, by providing a first zone 316 that is elliptical when viewed in a direction orthogonal to the first surface 324 (see FIG. 4C), that first zone 316 can present a circular area when viewed along a line that is orthogonal to a first face 328 of the polarizing beam splitter 308 (see FIG. 4B). In accordance with further embodiments of the present disclosure, where the light source 332 outputs light of a first linear polarization, the transmission area 318 of the first zone 316 can be coated so as to highly transmit light of the first linear polarization (e.g. a P-polarization) and to reflect light of other polarizations. A first face 328 of the polarizing beam splitter 308, through which a transmitted beam 336 is received, a second face 330 of the polarizing beam splitter 308, through which a return signal 348 is received, and a third surface 333 through which the reflected return signal is passed, can be provided with an antireflective coating.

In accordance with embodiments of the present disclosure, a light source 332, such as a laser, is positioned so as to direct a transmitted beam 336 that includes light of the first linear polarization through the first face 328 of the polarizing beam splitter 308. Moreover, the transmitted beam 336 is configured so as to pass through the first zone 316 formed in the mirrored reflecting surface of the second zone 312. The transmitted beam 336 is then passed through the polarizing beam splitter 308, through an optional quarter wave plate 340, which operates to circularly polarize the transmitted beam 336. The now circularly polarized transmitted beam 336 is then directed to a scene within the field of view of the LiDAR system 304 by a system scanner 344.

Light reflected from an object 128 within the scene encompassed by the field of view of the LiDAR system 304 is collected by the system scanner 344 as a return signal 348, and is passed through the optional quarter wave plate 340. The portion of the return signal 348 incident on the mirrored reflecting surface 314 of the second zone 312 is reflected toward a receiver 352. In addition, the portion of the return signal 348 incident on the transmission area 318 of the first zone 316 within the second zone 312 and having any polarization other than the first linear polarization is also reflected (fully or partially) toward the detector or receiver 352.

Accordingly, as can be appreciated by one of skill in the art after consideration of the present disclosure, a LiDAR system 304 as disclosed herein reduces the proportion of a return signal that is not received at the detector 352 as compared to various prior art LiDAR configurations. In particular, the majority of the area of the second zone 312 directs light received as part of the return signal 348 to the detector 352, regardless of polarization. Accordingly, light received as part of the return signal 348 that is incident on the first zone 316 having the second linear polarization is also reflected and thus directed to the detector 352. Only that portion of the light received at the LiDAR system 304 as part of the return signal 348 that is incident on the first zone 316 and that has the first linear polarization is not passed to the detector 352. Moreover, this improved utilization of light received as part of a return signal 348 is achieved without compromising the power of the transmitted beam 336 as compared to other monostatic LiDAR systems. This is particularly advantageous as the LiDAR system becomes more compact so the area of the first zone 316 becomes substantial compared to the second zone 312.

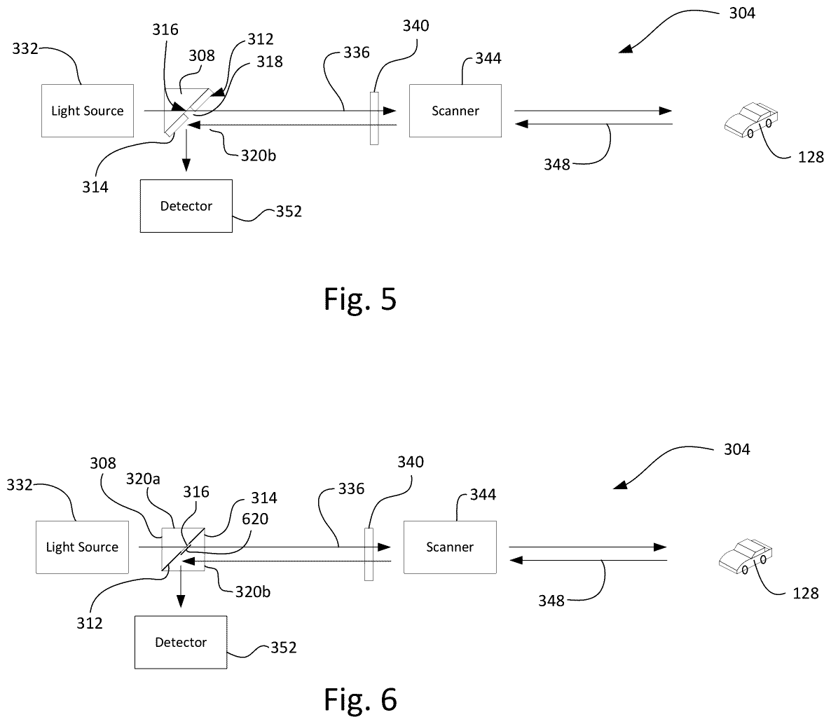

FIG. 5 depicts a LiDAR system 304 in accordance with embodiments of the present disclosure having a beam splitter 308, here a polarizing beam splitter configured as a half cube or single prism, that is combined with a high reflecting mirror 314 in the form of a square, plate, circle, or ellipse. A transmission area in the form of a transmission area or aperture 318 is formed in the plate. The aperture 318 can be configured as a hole within the plate, or as a coating or material that transmits light of a first linear polarization (e.g. a P-polarization) and that reflects light of other polarizations. Accordingly, a first zone 316 that is defined by a transmission area and that is polarization selective is provided within a second zone 312 that is defined by a mirror 314 and that is polarization agnostic (i.e. is not polarization selective). The LiDAR system 304 can otherwise be configured the same as or similarly to the LiDAR system of FIG. 3.

FIG. 6 depicts a LiDAR system 304 in accordance with embodiments of the present disclosure having a beam splitter 308 with a second zone 312 in the form of a mirrored reflecting surface 314 in which a first zone 316 in the form of a transmission area is formed. In such embodiments, a liquid crystal or other switchable medium 620 is disposed across the central transmission area (or across the entire beam splitting surface 324). The switchable medium 620 can then be electrically controlled to switch from transparent to reflective for all combinations of polarizations or individual polarizations. More particularly, in operation, the switchable medium 620 in such embodiments can be operated so that it is transmissive at a time a pulse of transmitted light 336 is to be passed, and can be operated so that it is reflective during a time period at which light reflected from an object 128 as part of a return signal 348 is received. The LiDAR system 304 of FIG. 6 can otherwise be configured the same as or similarly to the LiDAR systems of FIGS. 3 and 5.

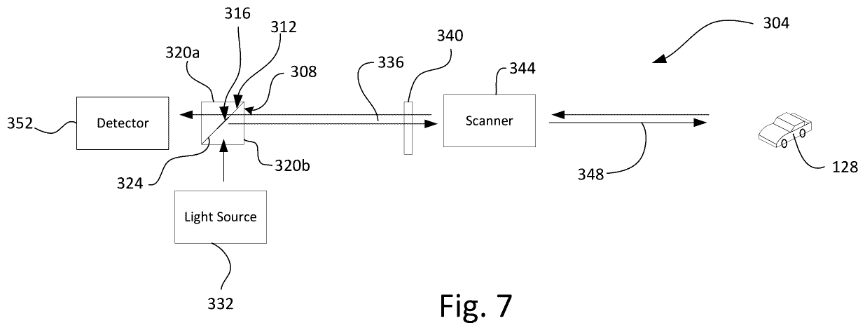

FIG. 7 depicts a LiDAR system 304 in accordance with embodiments of the present disclosure. In such embodiments, the LiDAR system 304 features a beam splitter 308 having beam splitting surface 324 with a first zone 316 with a polarization sensitive treatment, such as a polarization selective coating, that is configured to reflect light of a first linear polarization, and a second zone 312 that is configured to transmit light of any polarization. In such embodiments, light 336 having the first linear polarization is output from a light source 332 and is reflected by the first zone 316 of a beam splitter 308 to a scanner 344. The scanner 344 then directs the transmitted light within a field of view of the system 304. Light received as a return signal 348 that has been reflected from an object 128 or otherwise returned to the system 304 is passed by the scanner 344 to the beam splitter 308. Light in the return signal 348 that is incident on the second zone 312 is passed to the detector 352, regardless of the polarization of the light. In addition, light in the return signal 348 that has a second linear polarization, or any polarization other than the first polarization, is passed to the detector 352. Accordingly, only light in the return signal 348 having the first linear polarization, which is reflected back toward the light source 332, is not passed to the detector 352.

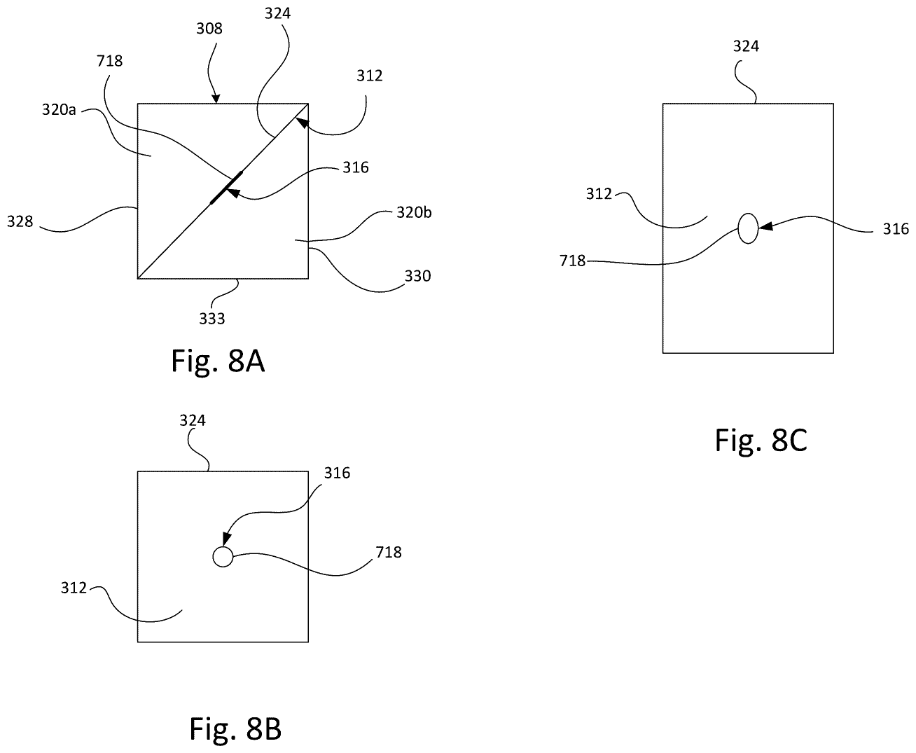

FIGS. 8A, 8B, and FIG. 8C, present a side view in elevation, a front view in elevation, and a view of beam splitting surface 324 along a line that is perpendicular to that surface, respectively, of a beam splitter 308 such as may be included in embodiments of the LiDAR system 304 as shown in FIG. 7. The beam splitter 308 can be formed from two triangular sections 320a and 320b that are joined to form a cube. The polarization selective surface 718 forming the first zone 316 can be disposed along the beam splitting surface 324 formed at the interface between the two triangular sections or prisms 320a and 320b. For example, the polarization selective surface 718 can be provided as a polarization selective coating on the beam splitting surface 324 of the first triangular section 320a. The polarization selective surface 718 can be configured to reflect light of a first linear polarization, and to transmit light of any polarization other than the first linear polarization. As another example, the polarization selective surface 718 can be provided as a polarization selective filter element disposed in an area corresponding to the first zone 316 of the beam splitter 308. The area of the first zone 316 can be formed as an area in which any polarization selective coating or overlay is absent. In accordance with embodiments of the present disclosure, the area of the first zone 316, when considered along a line that is orthogonal to the beam splitting surface 324, can be elliptical in form (see FIG. 8C), and can thus present a circular area when viewed along a line that is orthogonal to a first face 328 of the polarizing beam splitter 308 (see FIG. 8B). The exterior faces 328, 330, and 333 of the beam splitter 308 can be provided with an antireflective coating.

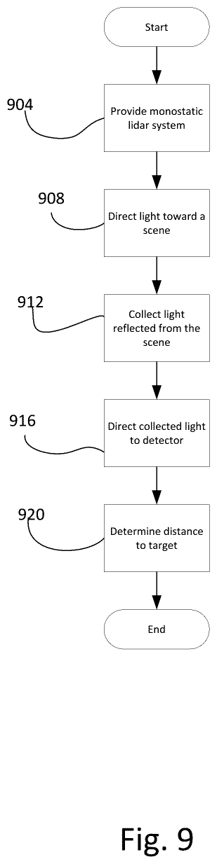

Aspects of a method in accordance with embodiments of the present disclosure are depicted in FIG. 9. Initially, a monostatic LiDAR system 304 as disclosed herein is provided (step 904). The LiDAR system 304 is configured with a beam splitter 308 that includes a beam splitting surface 324 having first 316 and second 312 zones. The first zone 316 is selective with respect to a polarization of light, while the second zone 312 is polarization agnostic (i.e. it reflects (or transmits) light of any polarization equally). The first 316 and second 312 zones can be disposed on a beam splitting surface 324. The beam splitting surface 324 is typically at an angle of 45 degrees relative to the exterior faces 328, 330, and 333 of the beam splitter. However, deviating from 45 degrees by a few degrees can provide the benefit of reducing back reflections off of the output window or face.

In operation, light having a first selected linear polarization is output from a light source 332 and is directed to the first zone 316 of the beam splitter 308. The light is transmitted or reflected, by the beam splitter 308, depending on the configuration of the first zone 316. The light can then be passed through an optional quarter wave plate 340, which circularly polarizes the light, and through a scanner 344, toward a scene (step 908). As can be appreciated by one of skill in the art after consideration of the present disclosure, the time at which the light source 332 outputs the transmitted light 336 is marked. Light incident on an object 128 within the scene is then reflected back to the LiDAR system 304, where it is collected by the scanner 344 (step 912).

Collected light is then directed to the detector 352 at the beam splitting surface 324 of the polarizing beam splitter 308 (step 916). As can be appreciated by one of skill in the art, light reflected from an object 128 within a scene or field of view and collected by the system 304 as a return signal 348 will generally have diverged. Portions of the return signal 348 incident on the second zone 312 of the beam splitter are reflected or transmitted to the detector 352, regardless of the polarization of that light. Portions of the return signal 348 incident on the first zone 316 and having a polarization other than the first linear polarization are reflected or transmitted to the detector 352, while portions of the return signal 348 incident on the first zone 316 and having the first linear polarization are transmitted or reflected to the light source 332, and thus are not part of the light available to the detector 352. However, because embodiments of the present disclosure provide a first zone 316 that is polarization selective, such losses are reduced as compared to alternative monostatic systems. In accordance with embodiments of the present disclosure that feature a switchable medium 620 across the transmission area 316, that switchable medium 620 is controlled to be transmissive at a time corresponding to the transmission of light 336 by the light source 332, and is further controlled to be reflective at a time corresponding to the receipt of light 348 reflected from an object 128 within a scene. Accordingly, where a switchable medium 620 is provided, light of all polarizations is reflected toward the detector 352 by the polarizing beam splitter 308.

The time at which the return signal 348 is received at the detector 352 is marked, and the amount of time that has elapsed between the sending of the transmitted light 336 and the receipt of the return signal 348 (i.e. the time of flight) is used to determine a distance to the object 128 (step 920). Angular information from the scanning system can be added to this range information in order to produce 3-dimensional information of the target 128.

The foregoing discussion has been presented for purposes of illustration and description. Further, the description is not intended to limit the disclosed systems and methods to the forms disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosed systems and methods, and to enable others skilled in the art to utilize the disclosed systems and methods in such or in other embodiments and with various modifications required by the particular application or use. It is intended that the appended claims be construed to include alternative embodiments to the extent permitted by the prior art.

What is claimed is:

1. A system, comprising:
a light source;
a detector;
a beam splitter, including:
a first zone disposed along a first portion of a beam splitting surface of the beam splitter, wherein the first zone is polarization selective;
a second zone disposed along a second portion of the beam splitting surface of the beam splitter, wherein the second zone is polarization agnostic, wherein the light source is positioned to direct light to the first zone, and wherein the detector is positioned to receive light from the first and second zones.

2. The system of claim 1, wherein the light source outputs light having a first linear polarization, and wherein the first zone reflects light of the first linear polarization.

3. The system of claim 2, wherein the second zone transmits light of any polarization.

4. The system of claim 3, wherein the first zone transmits light of any polarization other than the first linear polarization.

5. The system of claim 1, wherein the light source outputs light having a first linear polarization, and wherein the first zone transmits light of the first linear polarization.

6. The system of claim 5, wherein the second zone reflects light of any polarization.

7. The system of claim 6, wherein the first zone reflects light of any polarization other than the first linear polarization.

8. The system of claim 6, wherein the second zone is coated by a reflective material, and wherein the reflective material is absent from the first zone.

9. The system of claim 1, wherein the beam splitter is a polarizing beam splitter.

10. The system of claim 1, wherein the first zone is surrounded by the second zone.

11. The system of claim 1, wherein the first zone is elliptical when viewed along a line that is orthogonal to the beam splitting surface.

12. The system of claim 1, wherein the first zone is covered by a switchable medium.

13. The system of claim 12, wherein the switchable medium is a liquid crystal medium.

14. A monostatic LiDAR system, comprising:
a beam splitter, including:
a beam splitting surface;
a first zone disposed on the beam splitting surface, wherein the first zone is polarization selective; and
a second zone disposed on the beam splitting surface and surrounding the first zone, wherein the second zone is not polarization selective;
a light source, wherein the light source is disposed adjacent a face of the beam splitter, wherein light output by the light source has a first linear polarization, and wherein the light output by the light source is directed to the first zone of the beam splitter; and
a detector, wherein the detector is disposed adjacent another face of the beam splitter.

15. The monostatic LiDAR system of claim 14, wherein the first zone reflects light of the first linear polarization, wherein the second zone transmits light of any polarization.

16. The monostatic LiDAR system of claim 14, wherein the first zone transmits light of the first linear polarization, and wherein the second zone reflects light of any polarization.

17. A method, comprising:
transmitting light of a first linear polarization toward a scene through a first zone of a beam splitter;
receiving a return signal from the scene; and
passing light included in the return signal through the first zone and a second zone of the beam splitter to a detector.

18. The method of claim 17, wherein transmitting light of the first linear polarization toward a scene includes reflecting light of the first linear polarization output from a light source from the first zone, wherein passing light included in the return signal through the first zone of the beam splitter to the detector includes passing light of any polarization other than the first linear polarization through the first zone of the beam splitter, and wherein passing light included in the return signal through the second zone of the beam splitter to the detector includes passing light of any polarization through the second zone of the beam splitter.

19. The method of claim 17, wherein transmitting light of the first linear polarization toward a scene includes transmitting light of the first linear polarization output from a light source by the first zone, wherein passing light included in the return signal through the first zone of the beam splitter to the detector includes reflecting light of any polarization other than the first polarization from the first zone of the beam splitter to the detector, and wherein passing light included in the return signal through the second zone of the beam splitter to the detector includes reflecting light of any polarization from the second zone of the beam splitter to the detector.

20. The method of claim 17, further comprising:
while transmitting the light of the first linear polarization toward the scene through the first zone, operating a switchable medium so that it is transparent; and
while receiving the return signal from the scene, operating the switchable medium so that it is reflective.
